(19) United States
(12) Patent Application Publication
(10) Pub. No.: US 2019/0047432 A1
(43) Pub. Date: Feb. 14, 2019

(54) SECONDARY SOLAR CHARGING BATTERY SYSTEM FOR USE WITH A RECREATIONAL VEHICLE

(71) Applicant: Sheila Clark, Payette, ID (US)

(72) Inventor: Sheila Clark, Payette, ID (US)

(21) Appl. No.: 16/103,640

(22) Filed: Aug. 14, 2018

Related U.S. Application Data
(60) Provisional application No. 62/545,247, filed on Aug. 14, 2017.

(51) Int. Cl. B60L 11/18; B60L 8/00; H02J 7/35; H02J 7/00

(52) U.S. Cl. CPC B60L 11/1838; B60L 11/1812; B60L 11/1851; B60P 3/36; H02J 7/35; H02J 7/0075; B60L 8/003

(57) ABSTRACT

A secondary solar charging battery bank system electrically coupled to an existing power circuit of a vehicle that is also coupled to a primary battery bank on the vehicle is provided. The power circuit connects a plurality of electrical devices onboard the vehicle together. The system includes a secondary battery bank coupled to the vehicle, a solar module coupled to the vehicle and electrically coupled to the secondary battery bank, and a transfer switch electrically coupled to the secondary battery bank and power circuit of the vehicle. The transfer switch adjusts to a first position to electrically couple the secondary battery bank to the existing power circuit of the vehicle. The transfer switch adjusts to a second position to electrically couple an external shore power source to the existing power circuit of the vehicle.

### RELATED APPLICATION

The application claims priority to provisional patent application U.S. Ser. No. 62/545,247 filed on Aug. 14, 2017, the entire contents of which is herein incorporated by reference.

### BACKGROUND

The embodiments herein relate generally to power systems for vehicles. More specifically, embodiments of the invention are directed to a secondary solar charging battery system for use with a recreational vehicle.

Vehicles such as a recreational vehicle comprises a power circuit that electrically couples a main battery bank to a plurality of electrical devices and systems onboard the vehicle. These electrical devices may include, but are not limited to, lights, smoke and gas detection devices, range hood, water pump, furnace, power vents, refrigerator, air conditioner, microwave, water heater, television and other appliances. The main battery bank supplies electricity to the vehicle's onboard electrical devices and can be recharged using a charger connected to a shore power source or other external power source such as an electrical generator.

The industry standard installation of solar charging systems on recreational vehicles only provides charging to the main battery bank of the recreational vehicle. Any use of the power from the main battery bank drains the available power available for any and all power systems for the vehicle. If the battery storage of the main battery bank is fully drained, the onboard systems and electrical devices connected to the vehicle's power circuit are inoperable.

Several battery charging systems for use with a vehicle are disclosed in U.S. Patent Application Publication 2017/0267113, and U.S. Pat. Nos. 4,786,851 and 4,141,425. Although these devices perform battery charging tasks, these devices are limited because they comprise complex configurations and/or do not effectively provide a rechargeable secondary battery bank operable with the vehicle's main power circuit that can be used in conjunction with the vehicle's main battery bank and an external shore power source as desired.

As such, there is a need in the industry for a secondary solar charging battery system for use with a recreational vehicle that addresses the limitations of the prior art. Specifically, there is a need for an efficient secondary solar rechargeable battery bank system that can be used as an option to provide power to the vehicle's main power circuit in addition to the vehicle's main battery bank and/or an external shore power source.

### SUMMARY

A secondary solar charging battery bank system electrically coupled to an existing power circuit of a vehicle that is electrically coupled to a primary battery bank on the vehicle is provided. The power circuit connects a plurality of electrical devices onboard the vehicle together. The system is configured to adjust to a first mode where the system supplies on-demand electricity to the plurality of electrical devices and a second mode where an external shore power source supplies electricity to the plurality of electrical devices. The system comprises a secondary battery bank coupled to the vehicle, a solar module coupled to the vehicle and electrically coupled to the secondary battery bank, the solar module configured to generate electricity to charge the secondary battery bank, and a transfer switch electrically coupled to the secondary battery bank and the existing power circuit of the vehicle, wherein the transfer switch is configured to adjust to a first position to electrically couple the secondary battery bank to the existing power circuit of the vehicle, thereby supplying power from the secondary battery bank to the plurality of electrical devices on the vehicle, wherein the transfer switch is configured to adjust to a second position to electrically couple the external shore power source to the existing power circuit of the vehicle, thereby supplying power from the external shore power source to the plurality of electrical devices on the vehicle.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective cutaway view of certain embodiments of the secondary solar charging battery bank system; and

FIG. 2 depicts a schematic view of the electrical components in certain embodiments of the secondary solar charging battery bank system.

### DETAILED DESCRIPTION OF CERTAIN EMBODIMENTS

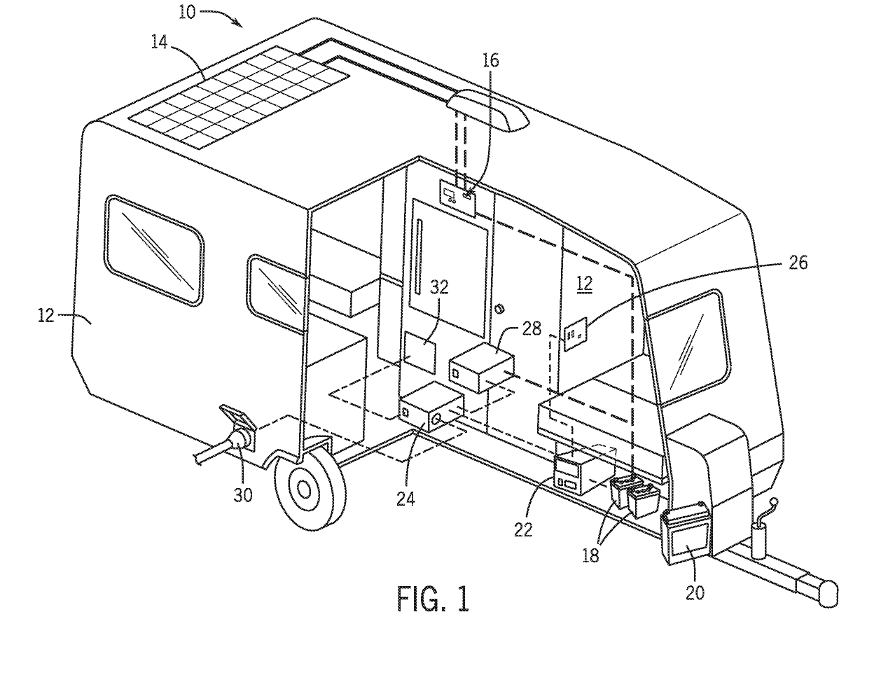

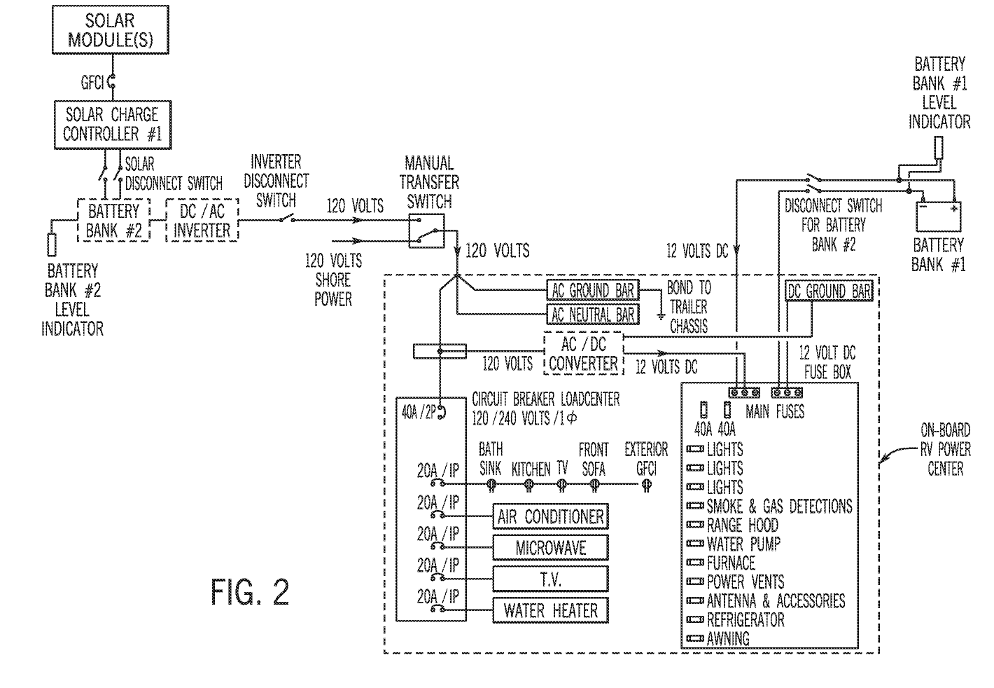

As depicted in FIGS. 1-2, secondary solar charging battery bank system 10 is configured for use with vehicle 12 in certain embodiments of the invention. Secondary solar charging battery bank system 10 is configured to supply electrical power to an existing power circuit of vehicle 12.

Vehicle 12 preferably is a recreational vehicle comprising main battery bank 20, which is configured to supply electricity to any number of onboard electrical systems and/or devices connected to the existing power circuit of vehicle 12. In an alternative embodiment, it shall be appreciated that vehicle 12 can be, but is not limited to, campers, trucks, cars, buses, other land-moving vehicles, aircraft and ships. The electrical systems and/or devices onboard vehicle 12 may include, but are not limited to, lights, smoke and gas detection devices, range hood, water pump, furnace, power vent, refrigerator, antenna and associated accessories, awning, air conditioner, microwave, water heater, television and other appliances.

In one embodiment, main battery bank 20 in a conventional operation is configured to supply electrical power to the existing power circuit of vehicle 12 to power the onboard electrical systems and/or devices. Main battery bank 20 comprises one or more batteries connected in series and is electrically coupled to the power circuit of vehicle 12 by wiring. In a default setting, main battery bank 20 can be recharged by a standard charger onboard vehicle 12 as is known in the field. In one embodiment, the charger of vehicle 12 is electrically coupled to a connection port/outlet of vehicle 12, which is coupled to an external power source such as shore power 30, a power generator and the like. In one embodiment, shore power 30 is supplied from a grid power source from a utility company.

In certain embodiments of the invention, solar charging battery bank system 10 is mounted to vehicle 12 and generally comprises solar module 14, solar charge controller 16, secondary battery bank 18, inverter 22 and transfer switch 24.

In one embodiment, solar module 14 is preferably mounted horizontally to the roof of vehicle 12 using any components including, but not limited to, mounting feet, brackets and mechanical fasteners such as bolts, washers and nuts. This allows solar module 14 to maximize exposure to sunlight. In one embodiment, one or more solar modules 14 can be coupled to the roof of vehicle 12 and be electrically coupled together. Solar charge controller 16 is coupled to vehicle 12 and electrically coupled to solar module 14 by wiring. Solar charge controller 16 is mounted in a location that is easy to view such as an interior wall of vehicle 12. This permits a user to monitor the operation of secondary solar charging battery bank system 10. In one embodiment, solar charge controller 16 is a GP-PWM-30 controller or similar type controller.

Solar charge controller 16 is electrically coupled to solar module 14 by wiring. In one embodiment, the wiring connecting solar charge controller 16 and solar module 14 is routed through a refrigerator vent on the roof of vehicle 12. Secondary battery bank 18 is disposed in an area within vehicle 12 that allows proper venting and is electrically coupled to solar charge controller 16 by wiring. Secondary battery bank 18 comprises any number of batteries coupled together by jumper wires/cables in series. In one embodiment, each battery comprises a 6V battery. In one embodiment, a level indicator is electrically coupled to secondary battery bank 18 to illustrate the level of electrical charge remaining in the battery bank.

Inverter 22 is disposed in vehicle 12 and is electrically coupled to secondary battery bank 18 and transfer switch 24 by wiring. Inverter 22 is configured to convert direct current supplied from secondary battery bank 18 to alternating current. In one embodiment, power switch 26 is electrically coupled to the existing power circuit of vehicle 12 to open or close the power circuit as desired.

Transfer switch 24 is coupled to the interior of vehicle 12 and is electrically coupled to inverter 22, and converter/charger 28 and AC panel 32 of the existing power circuit of vehicle 12. Transfer switch 24 is also electrically coupled to the connection port/outlet of vehicle 12, which is configured to couple to shore power 30, a power generator or other external power source. In a preferred embodiment, transfer switch 24 is a GP-TS 30 Amp transfer switch or similar type switch. Transfer switch 24 is configured to electrically couple secondary battery bank 18 to the power circuit of vehicle 12 in a first position or an external power source such as shore power 30 to the power circuit of vehicle 12 in a second position.

FIG. 2 depicts an exemplary electrical circuit diagram of secondary solar charging battery bank system 10 and the on-board power circuit of vehicle 12. The on-board RV power center depicts the power circuit of vehicle 12, which is electrically coupled to main battery bank 20 (Battery Bank #1). Main battery bank 20 is electrically coupled to the onboard electrical systems and/or devices connected to the power circuit of vehicle 12, which includes, but is not limited to, lights, smoke and gas detection devices, range hood, water pump, furnace, power vent, refrigerator, antenna and associated accessories, awning, air conditioner, microwave, water heater, television and other appliances. Any number of components known in the field such as disconnect switches, fuses, circuit breakers, AC/DC converters, chargers and controllers can be electrically coupled to the power circuit of vehicle 12.

As depicted in FIG. 2, solar module 14, solar charge controller 16, secondary battery bank 18, inverter 22 and transfer switch 24 of secondary solar charging battery bank system 10 are electrically coupled to the power circuit of vehicle 12. During an operational mode, solar module 14 generates electricity that flows through solar charge controller 16 to charge secondary battery bank 18. Solar charge controller 16 is configured to control the charging process of secondary battery bank 18.

In one embodiment, solar charge controller 16 prevents secondary battery bank 18 from overcharging. Solar charge controller 16 is configured to disconnect secondary battery bank 18 from solar module 14 via a solar disconnect switch when secondary battery bank 18 is fully charged. Solar charge controller 16 is configured to maneuver the solar disconnect switch to connect secondary battery bank 18 to solar module 14 when secondary battery bank 18 is not fully charged.

Electricity in the form of direct current flows from secondary battery bank 18 to inverter 22, which converts the direct current to alternating current. The resulting alternating current is readily available to be transferred to the power circuit of vehicle 12 via manual transfer switch 24. Inverter 22 is connected to or disconnected from transfer switch 24 by an inverter disconnect switch as shown in FIG. 2.

As depicted in FIG. 2, transfer switch 24 in the second position electrically couples the power circuit of vehicle 12 to the connection port/outlet of vehicle 12, which can be coupled to an external power source such as shore power 30, a power generator or other external power source. In one embodiment, shore power 30 is connected to the connection port/outlet of vehicle 12. Transfer switch 24 in the second position permits electricity from shore power 30 to pass through transfer switch 24 to the power circuit of vehicle 12. As a result, shore power 30 supplies power to the onboard electrical systems and/or devices connected to the power circuit of vehicle 12 and provides power to recharge main battery bank 20. Disconnecting shore power 30 from the connection port/outlet of vehicle 12 allows main battery bank 20 to supply power to the onboard electrical systems and/or devices connected to the power circuit of vehicle 12 until the main battery bank is drained.

Transfer switch 24 in the first position electrically couples the power circuit of vehicle 12 to secondary battery bank 18. This permits electricity from secondary battery bank 18 to pass through transfer switch 24 to the power circuit of vehicle 12. As a result, secondary battery bank 18 supplies power to the onboard electrical systems and/or devices connected to the power circuit of vehicle 12 and provides power to recharge main battery bank 20.

As such, secondary solar charging battery bank system 10 is advantageous because it provides an efficient secondary solar rechargeable battery bank system that can be used as an option to provide power to the vehicle's main power circuit in addition to the vehicle's main battery bank and/or an external shore power source. Secondary solar charging battery bank system 10 prevents the vehicle's main battery bank from completely discharging and minimizes the likelihood of an outage of the vehicle's onboard electrical systems and appliances.

It shall be appreciated that the components of secondary solar charging battery bank system 10 described in several embodiments herein may comprise any known materials in the field and be of any color, size and/or dimensions. It shall be appreciated that the components of secondary solar charging battery bank system 10 described herein may be manufactured and assembled using any known techniques in the field. It shall be appreciated that modifications to secondary solar charging battery bank system 10 can be made to provide a wide range of power outputs. For example, the number of solar modules and batteries used in the bank may vary. In one embodiment, 3 solar modules can be connected together to power up to 3,000 Watts of appliances, 2 solar modules can be connected together to power up to 2,000 Watts of appliances, and one solar module can be used to power up to 1,500 Watts of appliances.

Persons of ordinary skill in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

What is claimed is:

1. A secondary solar charging battery bank system electrically coupled to an existing power circuit of a vehicle that is electrically coupled to a primary battery bank on the vehicle, the power circuit connecting a plurality of electrical devices onboard the vehicle together, the system configured to adjust to a first mode where the system supplies on-demand electricity to the plurality of electrical devices and a second mode where an external shore power source supplies electricity to the plurality of electrical devices, the system comprising:
a secondary battery bank coupled to the vehicle;
a solar module coupled to the vehicle and electrically coupled to the secondary battery bank, the solar module configured to generate electricity to charge the secondary battery bank; and
a transfer switch electrically coupled to the secondary battery bank and the existing power circuit of the vehicle;
wherein the transfer switch is configured to adjust to a first position to electrically couple the secondary battery bank to the existing power circuit of the vehicle, thereby supplying power from the secondary battery bank to the plurality of electrical devices on the vehicle, wherein the transfer switch is configured to adjust to a second position to electrically couple the external shore power source to the existing power circuit of the vehicle, thereby supplying power from the external shore power source to the plurality of electrical devices on the vehicle.

2. The secondary solar charging battery bank system of claim 1, further comprising a charge controller electrically coupled to the solar module and the secondary battery bank, the charge controller configured to disconnect the solar module from the secondary battery bank when the secondary battery bank is fully charged.

3. The secondary solar charging battery bank system of claim 2, further comprising a solar disconnect switch electrically coupled to the solar module and secondary battery bank, wherein the charge controller is configured to maneuver the solar disconnect switch to disconnect the solar module from the secondary battery bank.

4. The secondary solar charging battery bank system of claim 3, wherein the charge controller is configured to maneuver the solar disconnect switch to connect the solar module to the secondary battery bank when the secondary battery bank is not fully charged.

5. The secondary solar charging battery bank system of claim 4, further comprising an inverter electrically coupled to the secondary battery bank and the transfer switch, wherein the inverter is configured to convert direct current supplied by the secondary battery bank to alternating current that is provided to the transfer switch.

6. The secondary solar charging battery bank system of claim 5, further comprising a switch electrically coupled to the transfer switch and the inverter, the switch configured to connect the inverter to the transfer switch or disconnect the inverter from the transfer switch.

7. The secondary solar charging battery bank system of claim 6, wherein the transfer switch in the first position electrically couples the inverter to the existing power circuit of the vehicle, wherein the transfer switch in the second position electrically couples the remote shore power source to the existing power circuit of the vehicle.

8. The secondary solar charging battery bank system of claim 7, further comprising an indicator electrically coupled to the secondary battery bank and configured to indicate a level of electrical charge in the secondary battery bank.

9. The secondary solar charging battery bank system of claim 8, wherein the secondary battery bank comprises a plurality of batteries connected together in series.

10. The secondary solar charging battery bank system of claim 9, wherein the solar module comprises a plurality of solar modules electrically coupled together.
